(19) United States
(12) Patent Application Publication
(10) Pub. No.: US 2020/0365968 A1
(43) Pub. Date: Nov. 19, 2020

(54) RFID TRANSPONDER

(71) Applicant: Confidex Oy, Tampere (FI)

(72) Inventor: Heikki Ahokas, Tampere (FI)

(21) Appl. No.: 16/762,584

(22) PCT Filed: Nov. 16, 2017
(86) PCT No.: PCT/FI2017/050788

§ 371 Date: May 8, 2020

(51) Int. Cl. H01Q 1/22; G06K 19/077; H01Q 1/38

(52) U.S. Cl. CPC H01Q 1/2225; H01Q 1/38; G06K 19/07786

(57) ABSTRACT

An RFID transponder includes an antenna, including a radiating element or elements, a parasitic radiating element or elements, the radiating element being matched to create a first polarization vector to be excited. The parasitic radiating element is arranged to sweep round the antenna at proximity of the radiating element so that the parasitic element is extending on two to all sides of the radiating element. The parasitic radiating element is matched to create a second polarization vector to be excited, the second polarization vector being perpendicular to the first polarization vector.

### CROSS-REFERENCE TO RELATED APPLICATIONS

This application is the National Stage of International Application No. PCT/FI2017/050788, filed Nov. 16, 2017, the contents of which is incorporated by reference herein.

### FIELD OF THE INVENTION

The invention relates to an RFID transponder.

### BACKGROUND

RFID transponders or RFID labels or RFID tags are used for identifying and/or tracking various objects. The RFID transponders are read at a distance by RFID readers.

However, every now and then arises a problem that the maximum reading distance should be extended.

### SUMMARY OF THE INVENTION

Viewed from a first aspect, there can be provided an RFID transponder, comprising an antenna, comprising a radiating element or elements, a parasitic radiating element or elements, said radiating element being matched to create a first polarization vector to be excited, said parasitic radiating element being arranged to sweep round the antenna at proximity of the radiating element so that the parasitic element is extending on two to all sides of the radiating element, and the parasitic radiating element being matched to create a second polarization vector to be excited, the second polarization vector being perpendicular to the first polarization vector.

Thereby an RFID transponder that allows for greater read distances in typical UHF RFID systems may be achieved.

The RFID transponder is characterised by an antenna, comprising a radiating element or elements, a parasitic radiating element or elements, said radiating element being matched to create a first polarization vector to be excited, said parasitic radiating element being arranged to sweep round the antenna at proximity of the radiating element so that the parasitic element is extending on two to all sides of the radiating element, and the parasitic radiating element being matched to create a second polarization vector to be excited, the second polarization vector being perpendicular to the first polarization vector. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit subtasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

### BRIEF DESCRIPTION OF FIGURES

Some embodiments illustrating the present disclosure are described in more detail in the attached drawings, in which

FIG. 1 is a schematic top view of a known RFID transponder,

FIG. 2 is a schematic top view of an RFID transponder according to the invention,

FIGS. 3a-3d are schematic top views of another RFID transponders according to the invention,

FIGS. 4a-4c are showing performance of various RFID transponders when read by a linear polarized reader antenna,

FIGS. 5a-5b are showing performance of various RFID transponders when read by a circular polarized reader antenna, and

FIGS. 6a-6c are showing performance of various RFID transponders on metal and plastic surfaces.

In the figures, some embodiments are shown simplified for the sake of clarity. Similar parts are marked with the same reference numbers in the figures.

### DETAILED DESCRIPTION OF THE INVENTION

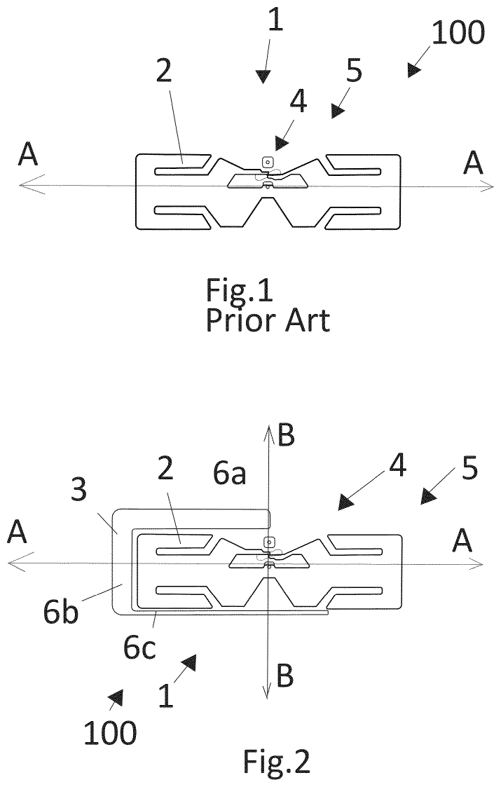

FIG. 1 is a schematic top view of a known RFID transponder.

The RFID transponder 100 is a layered structure that comprises an antenna 1, a radiating element 2 of the antenna and an IC 4.

Layers of the RFID transponder 100 are typically attached together with suitable adhesive layers and sealed by e.g. a silicone liner.

The antenna 1 and the IC 4 (together with further electronic components, if any) may be arranged to a structural module such as an inlay comprising a dielectric substrate.

The polarisation of the dipole signal excited by the antenna 2 has been shown by arrows A in FIG. 1.

A problem with the RFID transponder 100 shown in FIG. 1 is that when circular polarized reader antennas are utilized, there is an inherent link threshold power of 3 dB due to the mismatch in antenna polarization vectors. Additionally, when linear reader antennas are used and the polarization vector of the RFID transponder does not match with the polarization of the reader antenna, the transponder cannot be read at all (crosspolarization).

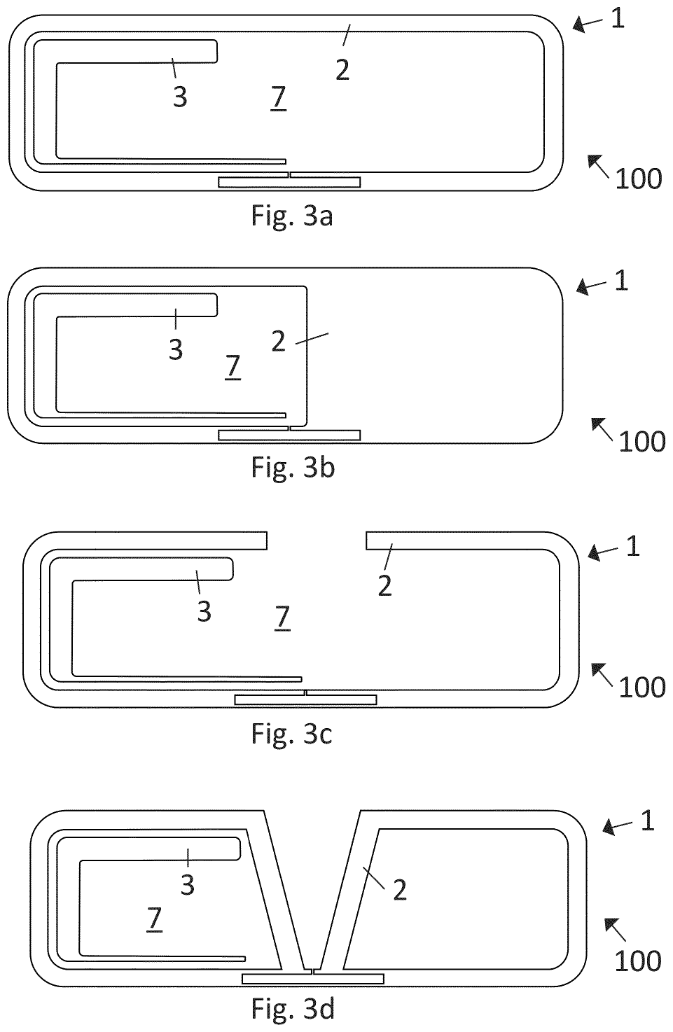

FIG. 2 is a schematic top view of an RFID transponder according to the invention. Also this RFID transponder 100 has a layered structure and comprises an antenna 1, a radiating element 2 of the antenna and an IC 4. The antenna shown in FIG. 2 is a dipole antenna. However, the antenna may also be e.g. a PIFA or a IFA.

Layers of the RFID transponder 100 are typically attached together with suitable adhesive layers and sealed by e.g. a silicone liner.

The RFID transponder 100 may further comprise a spacer layer described above.

The antenna 1, the IC 4 and any further electronic components may be arranged to a structural module such as an inlay comprising a dielectric substrate.

The radiating element 2 has been matched to create a first polarization vector to be excited, shown by arrows A in FIG. 1.

In addition, the RFID transponder 100 comprises a parasitic radiating element 3. The parasitic radiating element 3 has been matched for creating a second polarization vector, shown by arrows B, to be excited so that the second polarization vector is perpendicular to the first polarization vector A. In other words, the RFID transponder 100 has a dual polarization.

An advantage of the perpendicular polarization vectors A, B is that the link losses may be substantially minimized. As a result, the reading distance of the RFID transponder 100 is increased.

Another advantage is that if linear reader antennas are used, the RFID transponder 100 is readable in both vertical and horizontal orientation toward the reader antenna. Thus the orientation or position of the RFID transponder 100, or of the object labelled with the RFID transponder 100, does not have any significant role for maximum reading distance.

In the embodiment shown in FIG. 2, the radiating element 2 has a general outer shape of a rectangle, and the parasitic radiating element 3 has an inner edge following the general outer shape of said rectangle. The shape is not a precise rectangle, but there may be recesses, chamfers, and other details in the general shape of the radiating element. The purpose of the details may be e.g. tuning of the radiating element, facilitating the manufacturing of the transponder etc.

In the embodiment shown in FIG. 2, the parasitic radiating element 3 extends on three sides of the radiating element 2. The parasitic radiating element 3 comprises three subareas, first 6a of which being arranged to proximity of a first edge of the radiating element 2, second subarea 6b being arranged to proximity of a second edge of the radiating element 2, and third subarea 6c being arranged to proximity of a third edge of the radiating element 2. The first and second subareas 6a, 6b has equal width, whereas the width of said third subarea 6c is less than half of the width of said first and second subareas 6a, 6b. It is to be noted, however, that the dimensions of the subareas may be selected in another way, too.

In another embodiment, the parasitic radiating element 3 extends round the antenna 1 at proximity of the radiating element 2 on just two sides of the radiating element 2. In still another embodiment, the parasitic radiating element 3 extends around the antenna 1 at proximity of the radiating element 2 on all sides of the radiating element 2.

According to an aspect, the radiating element 2 may have a general outer shape of an ellipsoid, with or without one or more recess(es), and the parasitic radiating element 3 has an inner edge following the general outer shape of the ellipsoid.

According to another aspect, the radiating element 2 has a general outer shape of a circle, with or without one or more recess(es), and the parasitic radiating element 3 has an inner edge following the general outer shape of the circle.

According to still another aspect, the radiating element 2 has a general outer shape of a square, with or without one or more recess(es), and the parasitic radiating element 3 has an inner edge following the general outer shape of the square.

It is to be noted that there may be not only one but two or even more radiating elements 2 in the RFID transponder 100. Also there may be plurality of parasitic radiating elements 3 in the RFID transponder 100. An advantage is that the efficiency of the radiating elements 2, 3 may be enhanced and the reading distance of the RFID transponder thus extended.

The parasitic radiating element 3 may be coupled to the radiating element 2 by a magnetic (inductive) field, by an electric (capacitance) field, or by a electromagnetic (combination of inductive and capacitance) field. The distance between the radiating elements 2, 3 shall be as small as possible in order to ensure a good coupling between the radiating elements 2, 3. According to an aspect, the maximum distance is about 2 mm.

In an embodiment, the radiating element 2 and the parasitic radiating element 3 are arranged on the same plane surface in the RFID transponder 100. In another embodiment, said elements 2, 3 are arranged on different plane surfaces. For instance, the parasitic element 3 may be arranged on a plane on top of the radiating element 2, or alternatively, on a plane below the radiating element.

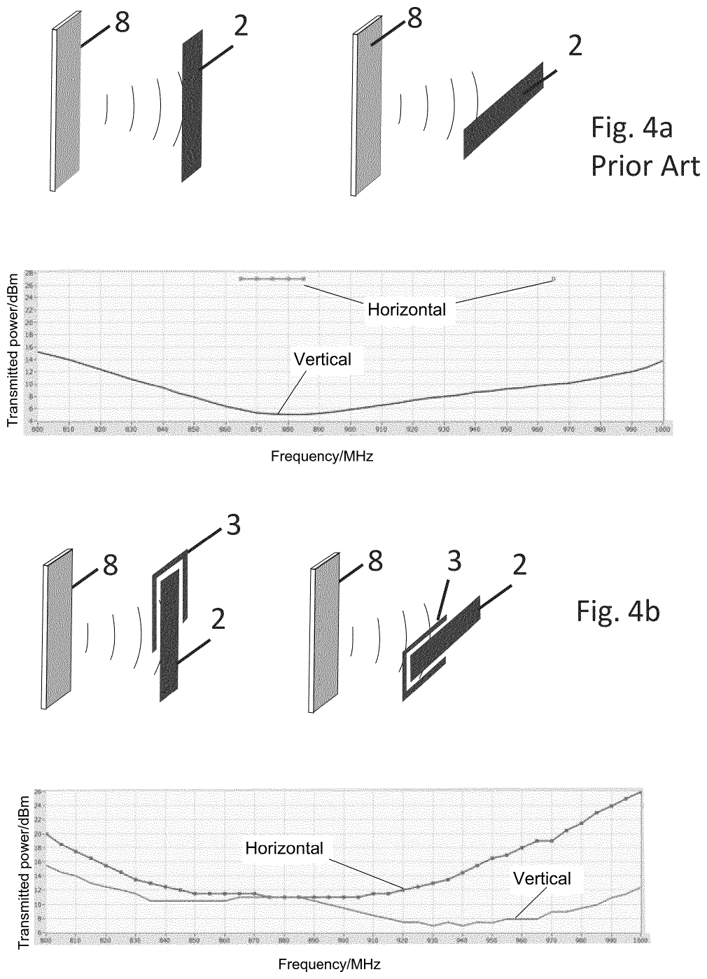

FIGS. 3a-3d are a schematic top view of another RFID transponders according to the invention. According to an aspect, the radiating element 2 may have at least one opening 7, and the parasitic radiating element 3 is arranged in said opening 7. The opening 7 may be closed one, as shown in FIGS. 3a, 3b and 3d, or partly open as shown in FIG. 3c. An advantage is that the dimensions of the RFID tag need not to be extended because of adding the parasitic element.

In FIGS. 3a-3c the shape of the opening 7 as well as the general outer shape of the radiating element 2 is a rectangle. However, the opening 7 and/or the parasitic radiating element 3 may have some another shape, such as elliptical, circular, trapezoid etc. For instance, FIG. 3d is showing an embodiment wherein the shape of the opening 7 is trapezoid.

The parasitic radiating element 3 has an outer edge that follows at least two inner edges of said opening 7, i.e. the inner edge of the radiating element 2.

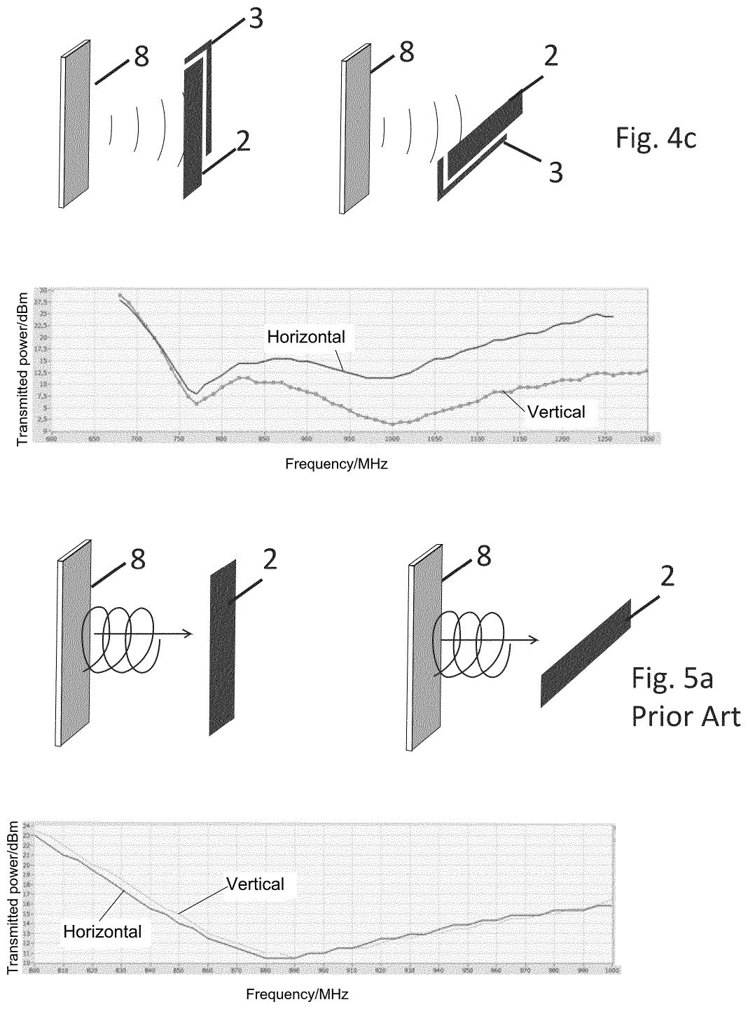

FIG. 4a is showing a known RFID transponder and its performance when read by a linear polarized reader antenna, FIG. 4b is showing an embodiment of a RFID transponder according to the invention and its performance when read by the linear polarized reader antenna shown in FIG. 4a, and FIG. 4c is showing a second embodiment of a RFID transponder according to the invention and its performance when read by a linear polarized reader antenna shown in FIG. 4a. It is to be noted that only the radiating elements of the RFID transponders are shown. Furthermore, the radiating element 2 is a dipole element. It is to be noted that x-axis is showing frequency as MHz and y-axis is showing transmitted power as dBm.

As shown by the diagram of FIG. 4a, the threshold power of the known RFID transponder at a frequency of 860 MHz is about 27 dBm when measured in a horizontal position shown in right view of FIG. 4a. A similar measurement was done to a RFID transponder comprising a parasitic radiating element 3 that extends on three sides of the radiating element 2, as shown in FIG. 4b. In this embodiment, the threshold power was about 12 dBm, only. In other words, the threshold power was dropped about 15 dB compared to the prior art solution.

Additionally it was measured an RFID transponder comprising a parasitic radiating element 3 that extends on two sides of the radiating element 2, as shown in FIG. 4c. In this embodiment, the threshold power was about 15 dBm. In other words, the threshold power was dropped about 12 dB compared to the prior art solution.

Thus one can conclude that RFID transponders according to the invention may be read by a linear polarized reader antenna even the polarization vector of the reader antenna is in angle of 90° compared to the polarization vector of the RFID antenna.

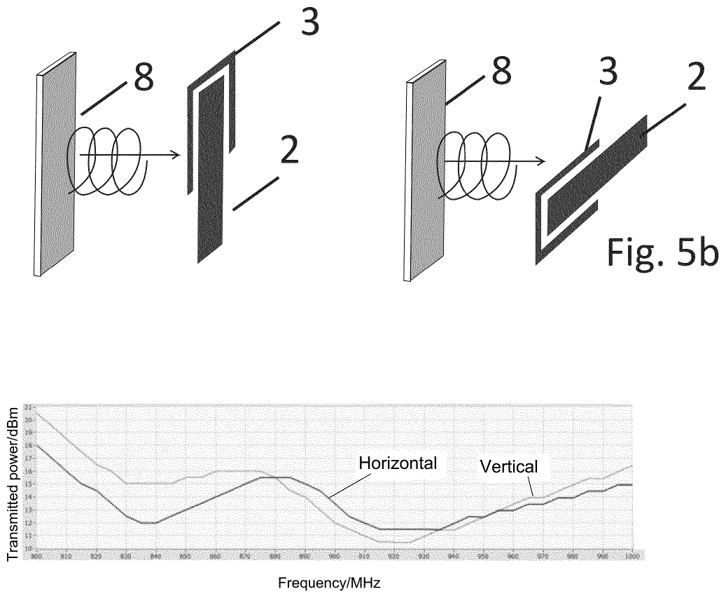

FIG. 5a is showing a known RFID transponder and its performance when read by a circular polarized reader antenna, and FIG. 5b is showing an embodiment of a RFID transponder according to the invention and its performance when read by the circular polarized reader antenna shown in FIG. 5a. It is to be noted that only the radiating elements of the RFID transponders are shown. Furthermore, the radiating element 2 is a dipole element.

When comparing the diagrams of FIG. 5a and FIG. 5b at a frequency of 830 MHz, it can be noticed that the threshold power in a vertical position was lessened by 3 dB and in a horizontal position by 5 dB.

Thus an advantage is that RFID transponders according to the invention may be read by a circular polarized reader antenna more far than prior art RFID transponders.

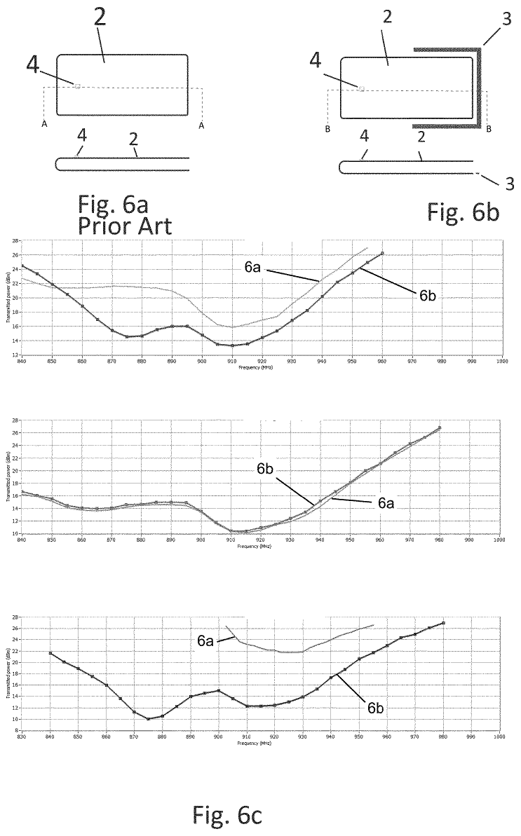

FIGS. 6a-6c are showing performance of various RFID transponders on metal and plastic surfaces.

In FIG. 6a there is shown a known RFID transponder seen from top and also as a cross-sectional view.

FIG. 6b is showing an embodiment of a RFID transponder according to the invention seen from top and as a cross-sectional view.

The upmost diagram of FIG. 6c is showing the losses of the RFID transponders 100 shown in FIGS. 6a, 6b when the transponder is attached on a plastic surface made of HDPE and read by a linear polarized reader antenna in vertical measurement (as shown in FIGS. 4a and 4b). It is to be noted that the transponder works if the surface is of another plastic, such as ABS, polyolefin or any other thermoplastic, or of thermoset or any other dielectric material. As can be seen, the threshold power of the known RFID transponder (marked as “6a”) is clearly higher as that of the RFID transponded according to the invention (marked as “6b”) in a broad frequency range from approximately 855 MHz to 960 MHz. It is to be noted that x-axis is showing frequency as MHz and y-axis is showing transmitted power as dBm.

The middle diagram of FIG. 6c is showing the losses of the RFID transponders 100 shown in FIGS. 6a, 6b when the transponder is attached on a metal surface and read by a linear polarized reader antenna in vertical measurement. As can be seen, the losses are substantially identical throughout the measured frequency range.

The lowest diagram of FIG. 6c is showing the losses of the RFID transponders 100 shown in FIGS. 6a, 6b when the transponder 100 is attached on a plastic surface and read by a linear polarized reader antenna in horizontal measurement (as shown in FIGS. 4a and 4b). As can be seen, the threshold power of the known RFID transponder is clearly higher through all the measured frequency range.

One can conclude that the performance of RFID transponders according to the invention is immune or at least substantially more immune to the surface material as known RFID transponders. Thus the RFID transponder according to the invention works well on both metal and plastic surfaces. Additionally, the readability of the transponder may be improved when read by a linear polarized reader antenna, because the transponder may receive energy through the parasitic radiating element 3 even if the (main) radiating element 2 is cross-polarizated with respect to the electromagnetic wave of the reader antenna.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 antenna

2 radiating element

3 parasitic radiating element

4 IC

6a-c parasitic subarea

7 opening

8 reader antenna

100 RFID transponder

A 1^{st} polarization vector

B 2^{nd} polarization vector

1. An RFID transponder comprises:
an antenna, comprising a radiating element or elements,
a parasitic radiating element or elements,
said radiating element being matched to create a first polarization vector to be excited,
said parasitic radiating element being arranged to sweep round the antenna at proximity of the radiating element so that the parasitic element is extending on two to all sides of the radiating element, and
the parasitic radiating element being matched to create a second polarization vector to be excited, the second polarization vector being perpendicular to the first polarization vector.

2. The RFID transponder as claimed in claim 1, wherein the radiating element has a general outer shape of a rectangle, with or without one or more recess(es), and
the parasitic radiating element has an inner edge following the general outer shape of the rectangle.

3. The RFID transponder as claimed in claim 2, wherein the parasitic radiating element extends on three sides of the radiating element.

4. The RFID transponder as claimed in claim 3, wherein the parasitic radiating element comprises three subareas, first of which being arranged to proximity of a first edge of the radiating element,
second subarea being arranged to proximity of a second edge of the radiating element, and
third subarea being arranged to proximity of a third edge of the radiating element, wherein
said first and second subareas having at least essentially equal width, and width of said third subarea being half or less than half of the width of said first and second subareas.

5. The RFID transponder as claimed in claim 1, wherein the radiating element has a general outer shape of an ellipsoid, with or without one or more recess(es), and
the parasitic radiating element has an inner edge following the general outer shape of the ellipsoid.

6. The RFID transponder as claimed in claim 1, wherein the radiating element has a general outer shape of a circle, with or without one or more recess(es), and
the parasitic radiating element has an inner edge following the general outer shape of the circle.

7. The RFID transponder as claimed in claim 1, wherein the radiating element has at least one opening, and
the parasitic radiating element being arranged in said opening, wherein the parasitic radiating element has an outer edge following at least two inner edges of said opening.

8. The RFID transponder as claimed in claim 1, wherein the parasitic radiating element is arranged to couple to the radiating element by a magnetic (inductive) field.

9. The RFID transponder as claimed in claim 1, wherein the parasitic radiating element is arranged to couple to the radiating element by an electric (capacitance) field.

10. The RFID transponder as claimed in claim 1, wherein the parasitic radiating element is arranged to couple to the radiating element by an electromagnetic (combination of inductive and capacitance) field.

11. The RFID transponder as claimed in claim 1, wherein the radiating element(s) and the parasitic radiating element(s) are arranged on the same plane surface in the RFID transponder.

12. The RFID transponder as claimed in claim 1, wherein at least one parasitic element is arranged on a different plane surface as the radiating element(s).

13. The RFID transponder as claimed in claim 12, wherein the at least one of said parasitic element(s) is arranged on a plane on top of the radiating element(s).
